(19) United States
(12) Patent Application Publication
(10) Pub. No.: US 2015/0231695 A1
(43) Pub. Date: Aug. 20, 2015

(54) BRAKE CALIPER HOUSING HAVING DIFFERENT STRENGTH AND METHOD FOR MANUFACTURING THE SAME

(71) Applicants: Hyundai Motor Company, Seoul (KR); Kia Motors Corporation, Seoul (KR)

(72) Inventors: Jae-Young Lee, Yongin (KR); Byung-Chan Lee, Suwon (KR); Jai-Min Han, Suwon (KR); Yoon-Joo Rhee, Seoul (KR); Yoon-Cheol Kim, Suwon (KR)

(73) Assignees: KIA MOTORS CORPORATION, Seoul (KR); HYUNDAI MOTOR COMPANY, Seoul (KR)

(21) Appl. No.: 14/556,159

(22) Filed: Nov. 30, 2014

(30) Foreign Application Priority Data
Feb. 20, 2014 (KR) 10-2014-19666

(51) Int. Cl. B22D 15/00; B22D 31/00; B22D 17/22; F16D 65/00

(52) U.S. Cl. CPC B22D 15/00; F16D 65/0068; B22D 31/002; B22D 17/2218

(57) ABSTRACT

Disclosed are a brake caliper housing and a method for manufacturing the same. The method for manufacturing the brake caliper housing includes: injecting a melt into a mold comprising a cavity of at least one or more of brake caliper housings; cooling the molded brake caliper housing having symmetric physical properties on a left portion and a right portion. Particularly, a cooling rate of the melt of a part in which a chiller is installed during cooling may increase to selectively improve strength by installing the chiller on the outer surface of the cavity. Accordingly, the bilateral symmetric microstructure on the left portion and the right portion may be obtained and deviations in physical properties between the left and the right portions of the manufactured brake caliper housing may be within about 5% and a pearlite fraction in the contact may increase, thereby improving the NVH performance.

### CROSS-REFERENCE TO RELATED APPLICATION

This application claims under 35 U.S.C. §119a the benefit of Korean Patent Application No. 10-2014-19666 filed on Feb. 20, 2014, the entire contents of which are incorporated herein by reference.

### TECHNICAL FIELD

The present invention relates to a brake caliper housing having different strength and a method for manufacturing the brake caliper housing. Particularly, the brake caliper housing may have bilateral symmetric physical properties, and thus vibration, noise or the like may be reduced and improve NVH performance by improving strength at a portion where stress is concentrated.

### BACKGROUND

In general, a brake mounted on a vehicle is a device for decelerating or stopping the vehicle while driving or maintaining a stopped state, and are categorized into a drum brake, a disc brake or the like.

The disc brake is a device for braking wheels by frictional force generated by bringing brake pads into close contact with discs, and includes: discs rotating while being connected to the wheels; brake pads coming into close contact with the discs to generate frictional force; a brake caliper housing including a cylinder or the like on which hydraulic pressure acts; and a brake caliper including a piston or the like that reciprocates inside the cylinder to push the brake pads.

Typically, the brake caliper has a form that is operated by hydraulic pressure and wraps the brake discs by including a hydraulic device or the like that brings the pads of the vehicle into close contact with the discs to stop the rotation of the discs.

When the master cylinder is subjected to the hydraulic pressure so as to actuate the disc brakes equipped with the brake calipers, hydraulic pressure is generated in brake fluid within the cylinder, and the pressure is transmitted into the cylinder. When the transmitted pressure in the cylinder pushes the piston, the pads come into contact with the disc surfaces to apply the pressure onto the contact pads. Thus, frictional force is generated between the discs and the pads, and the frictional force brakes the discs.

Further, drivers prefer vehicles to have improved NVH (noise, vibration and harshness) performance associated with noise, vibration or the like during braking, in addition to the basic braking performance. Therefore, vehicle manufacturers have designed disc brakes in which occurrences of vibration and noise are suppressed through selection of materials, dynamics characteristics, structural analysis or the like for the reduction of vibration, noise or the like during braking, and have mass-produced disc brakes in which efficiency is confirmed through tests or the like.

In particular, one of the parts that cause occurrences of vibration and noise during operation of the disc brake may be the brake caliper housing. A ductile cast iron having excellent mechanical physical properties or the like compared to costs thereof has been used for manufacturing brake caliper housing, and various types from FCD450 grade to FCD700 grade have been used according to the request of strength and rigidity.

However, when manufacturing the conventional brake caliper housing, a difference in the cooling rate occurs even in the same part depending on the shape or temperature of the mold into which melt is injected, and thus, heterogeneous microstructures in each part may be formed. Therefore, substantial deviations in the physical properties such as strength and Young's modulus may be caused in each part of the same brake caliper housing, which may further generate vibration, noise or the like due to asymmetric deformation on the left portion and right portion of the brake caliper housing during the braking operation.

In addition, there has been a problem in that stress is generated in the brake caliper housing by hydraulic pressure generated during the braking operation, but the stress is concentrated on a contact section in which a finger section and a bridge section of the caliper housing are connected. As consequence, deformation, breakage or the like of the contact section may be easily induced, and thus, vibration, noise or the like may occurs.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Now we provide the present invention to solve the technical difficulties in the related art. Accordingly, vibration, noise or the like during the braking operation may be improved to improve the braking NVH performance, by having the symmetric microstructure and by improving strength and rigidity of the contact section in a brake caliper housing of a vehicle brake in which the stress is concentrated.

In one aspect, the present invention provides a method of manufacturing a brake caliper housing.

In an exemplary embodiment, the method of manufacturing the brake caliper housing may include: injecting a melt into a mold constituted by a cavity of at least one or more of brake caliper housings; and cooling the molded brake caliper housing having symmetric physical properties between a left portion and a right portion. Particularly, the cooling rate of the melt of a part in which a chiller is installed during cooling may substantially increase to selectively improve strength by installing the chiller on the outer surface of the cavity.

In certain exemplary embodiments, the cavity may have two melt inlets positioned symmetrically to each other on a left portion and a right portion of the mold.

In yet certain exemplary embodiments, the outer surface of the cavity in which the chiller is installed may be an outer surface which corresponds to a contact section of the casted brake caliper housing.

In certain exemplary embodiments, the brake caliper housing may be manufactured so that a Young's modulus variation between a left portion and a right portion thereof may be within about 5%. Further, the brake caliper housing may be manufactured so that a ferrite structure deviation between the left portion and the right portion thereof may be within about 10%.

As described above, in various exemplary embodiments of the present invention, since the brake caliper housing may have symmetric microstructures on the left portion and the right portion the NVH performance may be improved by suppressing asymmetric deformation in the left and the right portions that causes vibration, noise or the like when the disc brake is operated.

Further, in the method of manufacturing the brake caliper housing according to exemplary embodiments of the present invention, deformation and breakage of the contact section during operation of the disc brake may be suppressed to ensure stable and uniform braking operation and suppress vibration, noise or the like, by improving strength, rigidity or the like at the contact section in which the stress is concentrated by regulating the cooling rate of each part.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 illustrates a perspective view of an exemplary brake caliper housing that forms a caliper as one of components of a disc brake device according to an exemplary embodiment of the present invention.

FIG. 2 is a side view of an exemplary brake caliper housing and deformation may occur under stress in a circled contact section.

FIG. 3 is a plan view of an exemplary brake caliper housing mold according to an exemplary embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terms and words used in the specification and claims should not be construed as being limited to general or dictionary meaning, and should be construed as meaning and concepts conforming to the technical spirit of the present invention, based on a principle that the inventors can suitably define concepts of the terms in order to describe their own inventions in the best way.

Hereinafter, the present invention will be described in detail with reference to the drawings or the like.

The present invention relates to a brake caliper housing having different strength and a method for manufacturing the brake caliper, and in a point of view, the present invention relates to a brake caliper housing having different strength.

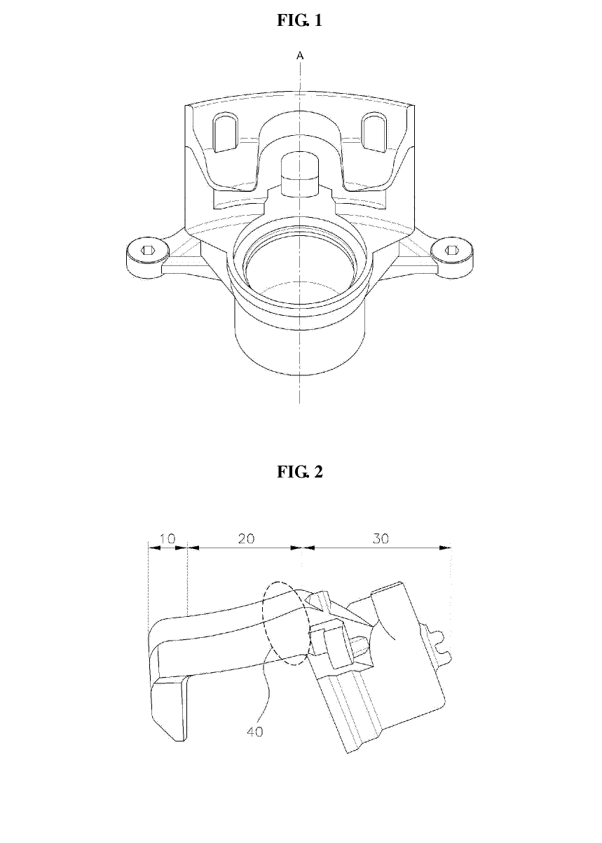

In one aspect, provided is a brake caliper housing which may include a finger section, a bridge section, a cylinder section or the like. In particular, the physical properties of the brake caliper housing may be in bilateral symmetry. As used herein, the term “bilateral symmetry” refers to symmetry of a left portion and a right portion on a symmetry plane A as shown in FIG. 1. The bilateral symmetry also refers to a symmetry having a mirror image on the symmetry plane A. In addition, a pearlite fraction of a contact section 40 in FIG. 2 in which the finger section is connected to the bridge section may be about 50% or greater.

In FIG. 1, a perspective view of an exemplary brake caliper housing forming the caliper which is one of the components of the disc brake device is illustrated, and in FIG. 2, a side view of an exemplary brake caliper housing is illustrated. Particularly, the circled contact section where deformation may occur under stress is illustrated.

As shown in FIGS. 1-2, in an exemplary embodiment, the brake caliper housing may include: a finger section 10 on which a brake shoe coming into contact with one surface of the brake disc to generate a braking force may be mounted; a cylinder section 30 which is located on an opposite surface of the finger section 10 and on which a hydraulic piston capable of moving a brake shoe capable of coming into contact with the other surface of the brake disc via hydraulic pressure may be mounted; a bridge section 20 that may connect the finger section 10 and the cylinder section 30; and a contact section 40 in which the bridge section 20 may be connected to the cylinder section 20. In particular, a pearlite fraction of the contact section 40 may be of about 50% or greater, and the pearlite fraction of sections other than the contact section 40 may be less than about 50%. As used herein, “pearlite” may be a layered and two-phase structure comprising distinctive ion compound, such as ferrite and cementite, which may be formed in a steel and a cast irons. Pearlite in a composition may provide wear resistance due to layered or a strong lamellar structure of ferrite and cementite.

Hydraulic pressure which is generated in the master cylinder of the brake device moves the hydraulic piston positioned in the cylinder section 30, and the braking force occurs by friction generated by contact of the brake shoe to both sides of the brake disc rotating by the movement of the hydraulic piston. When the brake device is activated, the hydraulic piston positioned in the brake caliper housing is moved by the hydraulic pressure, and a force generated in the piston while moving may act as a pressure in the brake disc and act as a stress in the brake caliper housing. Then, stress applied on the brake caliper housing may increase in proportion to the increase in the pressure of the piston, but the stress may be concentrated on the contact section 40 which is a substantially vulnerable part in the brake caliper housing.

In the related arts, as shown in FIG. 2, due to the stress, deformation or the like may occur in the circled contact section 40 or the like, which leads to shortened life of the brake caliper housing and deterioration of brake function. Since the contact section 40 may be bent and deformed by stress concentrated on the contact section 40, the present invention provides the brake caliper housing in which strength and rigidity of the contact section 40 may be reinforced.

In particularly, the materials of the caliper housing according to an exemplary embodiment of the present invention may be, but not limited to, gray cast iron, ductile cast iron, malleable cast iron, alloy cast iron, chilled cast iron, CV graphite cast iron, austempered ductile cast iron and the like. Among others, the ductile cast iron having substantial mechanical properties such as tensile strength, and elongation compared to the costs thereof may be particularly used. It is also appreciated that ductile cast iron from FCD450 grade to FCD700 grade may provide a range of options for the materials of the caliper housing, but the examples are not limited thereto.

The ductile cast iron, as used herein, may form pearlite or ferrite depending on the cooling rate during manufacturing the cast through casting. The pearlite may be formed at a greater cooling rate than a predetermined rate and may have a layered structure in which ferrite and cementite are alternately superimposed, thereby improving physical properties such as strength. In contrast, ferrite may be formed at a lower cooling rate than the predetermined rate, and may have less strength than that of the pearlite, although the ferrite may have high ductility.

The conventional brake caliper housing has a pearlite fraction of about less than about 50%, and has a high probability of occurrence of mechanical deformation or the like in the contact section 40. However, according to an exemplary embodiment of the present invention, the fraction of pearlite in the contact section 40 of the brake caliper housing may be about 50% or greater, and thus the contact section 40 may have improved strength or the like. As consequence, the mechanical deformation or the like may be suppressed when the stress is concentrated during the braking operation.

The Young's modulus deviation between the contact section 40 and other sections may be about 5% or greater. As used herein, “Young's modulus” refers to a measurement of the tensile strength or elastic strength. When the Young's modulus deviation is less than about 5%, the effect of mechanical deformation at the contact section 40 may be reduced. Furthermore, the pearlite fraction of the contact section 40 may be about 50% or greater. Moreover, since the conventional caliper housing has an asymmetric microstructure on the left portion and the right portion, due to asymmetric differences on the left portion and the right portion such as the pearlite fraction, the ferrite fraction and a spheroidizing ratio. When stress occurs in the brake caliper housing due to the movement of the hydraulic piston or the like, asymmetric deformation may be caused on the left portion and the right portion. Therefore, vibration, noise or the like may occur, and NVH (noise, vibration and harshness) performance may be reduced.

However, according to an exemplary embodiment of the present invention, the brake caliper housing may have bilateral symmetry based on the symmetric plane A leading to the finger section 10 of the brake caliper housing, the bridge section 20, the contact section 40, and the cylinder section 30. Accordingly, the Young's modulus deviation between the left part and the right part of the brake caliper housing may be within about 5%, and the left and right ferrite structure deviation may be within about 10%.

As evidenced by such reduced deviation in Young's modulus, the tissue difference or the like, the brake caliper housing according to an exemplary embodiment of the present invention may have a bilateral symmetric internal microstructure based on the symmetry plane A. Accordingly, such bilateral symmetric internal microstructure on the left portion and the right portion of the symmetry play A may absorb vibration, noise or the like generated in the brake caliper housing and the disc, since the symmetric deformation of the brake caliper housing may be suppressed during operation of the disc brake. Further, the NVH performance may be improved.

In other aspect, the brake caliper housing having the different strength according to various exemplary embodiments of the present invention may be applied to a vehicle disc brake or the like.

In another aspect, the present invention provides a method for manufacturing the brake caliper housing having the different strength.

The brake caliper housing having the different strength according to exemplary embodiments of the present invention may be manufactured through casting or the like. In an exemplary embodiment, the method for manufacturing the brake caliper housing may include: injecting a melt into a mold constituted by a cavity of at least one or more of one brake caliper housings; cooling to the casted a brake caliper housing having left and right symmetric physical properties. Particularly, a cooling rate of the melt of a part in which a chiller is installed during cooling may substantially increase to selectively improve the strength, by installing the chiller on the outer surface of the cavity. In certain exemplary embodiments, the cavity may have two melt inlets which are positioned symmetrically on left and right portions.

In an exemplary embodiments, the method for manufacturing the caliper housing may include steps of: a first step of melting a ductile cast iron to manufacture a melt; a second step of injecting the melt through two melt inlets positioned in bilateral symmetry on left and right ends of the symmetry plane of the cavity of the brake caliper housing shape; a third step of manufacturing castings by cooling the melt; a fourth step of separating the manufactured castings from the mold; a fifth step of cutting the castings separated from the mold per each brake caliper housing to manufacture the brake caliper housing or the like.

When injecting the melt into the mold, multiple cavities of the caliper housing shape connected by sprues or the like are provided in the conventional mold having one melt inlet. However, when the melt is injected only in one direction in the cavity of a single caliper housing shape, the difference in physical properties may be generated from the difference in the cooling rate even in the cavity of the same single caliper housing shape. For example, the melt injected first may be cooled prior to the melt injected later depending on the shape and temperature of the mold. Accordingly, since the microstructures asymmetrical to each other may be formed in the interior of the brake caliper housing which is casted in the such manner, variations in physical properties such as asymmetric Young's modulus and hardness may be generated, and the NVH performance of the brake may be reduced by vibration and noise generated from the caliper housing and the disc during operation of the disc brake due to such variations.

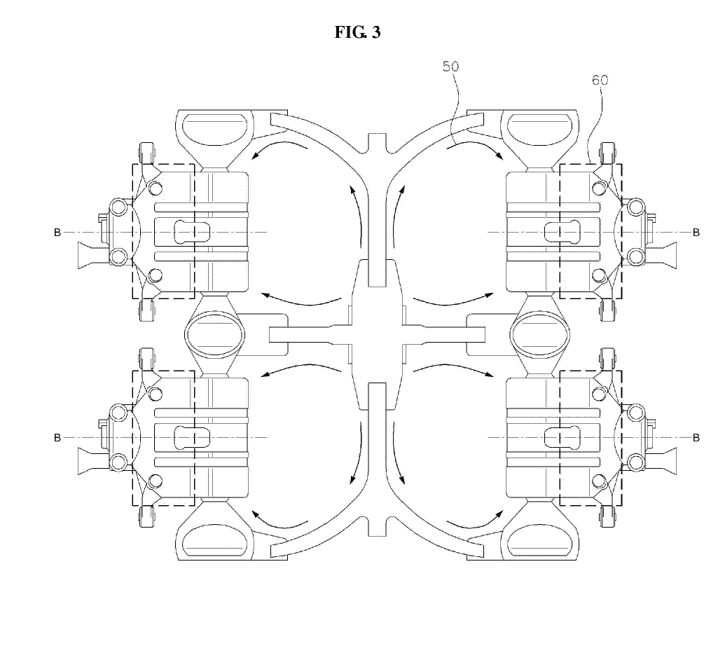

However, in the melt injecting method according to an exemplary embodiment of the present invention, as shown in FIG. 3, since the melt is injected into the cavity of one single caliper housing shape through two melt inlets symmetrically positioned on both left and right ends based on a symmetric plane B along a melt injection direction 50, the difference in the cooling rate in the mold may be reduced significantly as compared to the conventional injecting method in which injecting the melt is performed in one direction.

As such, the deviation of Young's modulus between the left portion and the right portion of the brake caliper housing which is in bilateral symmetry on the symmetry plane B over the finger section of the brake caliper housing as shown in FIG. 3, the bridge section, the contact section, and the cylinder section may be manufactured to have the deviation within about 5%. Particularly, the deviation in the left and right ferrite structure may be within about 10%.

In certain exemplary embodiments, the caliper housing may be manufactured to have a substantially symmetric microstructure. When the caliper housing has a symmetric microstructure, physical properties variations may decrease, vibration and noise generated from the caliper housing and the disc during operation of the disc brake may be suppressed, and thus, the brake NVH performance may be improved.

Further, as shown in FIG. 3, the chiller located in the contact section 60 of the chiller on the outside of the mold can increase the cooling rate of the melt in the mold. In certain exemplary embodiments of the present invention, by installing the chiller on the outer surface of the cavity, the cooling rate of the melt within the cavity may substantially increase. Particularly, the outer surface on which the chiller is installed may be an outer surface corresponding to the contact section of the casted brake caliper housing, thereby obtaining a result in which strength of the contact section may be improved by increasing the cooling rate of the melt in the cavity due to the chiller. Meanwhile, the contact section 60 of the chiller may be an exemplary part of the brake caliper housing in which the chiller can come into contact with the mold, but the examples are not limited thereto

In other certain exemplary embodiments, the outer surface of the cavity as the outer surface of the mold in which the chiller is positioned may be about 80% or less of a width from the outer surface of a position where the cylinder section of the caliper housing is formed to the outer surface of a position where the finger section is formed. In addition, the outer surface of the cavity may correspond to the contact section of the casted brake caliper housing.

In certain exemplary embodiments, the cooling of the melt within the mold positioned in a section with which the chiller comes into contact may be greater by about 100 seconds than the cooling of the melt within the mold positioned in a section with which the chiller does not come into contact.

In yet certain exemplary embodiments, the Young's modulus variation between the section affected by the cooling by the contact of the chiller and the unaffected section may be about 5% or greater. The Young's modulus deviation may be derived from the differences in the size and shape of graphite due to the difference in cooling rate, and may be related to the mechanical deformation suppressing effect.

In still certain exemplary embodiments, since the section affected by the cooling by the contact of the chiller has a substantially greater pearlite fraction, mechanical physical properties such as strength may be improved compared to the section that is not affected by the chiller. In other words, the outer surface portion of the mold coming into contact with the chiller may be the contact section in which the bridge section is connected to the cylinder section in the manufactured brake caliper housing, since the contact section may require substantially high strength in accordance to the concentrated stress during the braking operation.

In another certain exemplary embodiments, the pearlite fraction of castings manufactured in the section with which the filler comes into contact may be about 50% or greater. Particularly, in the manufactured brake caliper housing, the pearlite fraction of the section with which the chiller comes into contact may be 50% or greater. When the pearlite fraction increase, the mechanical properties may be improved, and thus the deformation due to stress or the like applied to the brake caliper housing may be suppressed. Also, the chiller may be, but not limited to, a mass of iron.

In addition, cooling water or compressed gas instead of the chiller and can increase the cooling rate may be used, but not limited thereto.

Further, since the section cooled without being affected by the chiller has the fraction of ferrite of about 50% or greater, effects such as high ductility or the like, reducing brittleness of the brake caliper housing, and absorbing the vibration or shock may be obtained thereby extending the service life of the brake caliper housing.

### EXAMPLE

Hereinafter, the present invention will be explained in more detail by way of exemplary embodiments. These embodiments are intended to only illustrate the present invention, and it will be obvious to those skilled in the art that the scope of the present invention is not construed as being limited to these embodiments.

After manufacturing an embodiment and a comparative example of the brake caliper housing having the different strength according to exemplary embodiments of the present invention, the physical properties such as tensile strength, elongation and hardness were measured.

TABLE 1

| | Classification | | | | | |
|---|---|---|---|---|---|---|
| | | | Mn | P | S | Fe |
| | C (wt %) | Si (wt %) | (wt %) | (wt %) | (wt %) | (wt %) |
| FCD450 | 2.29 | 2.67 | 0.51 | 0.077 | 0.006 | balance |

In Table 1, a composition and contents of an FCD450 sample are shown according to an exemplary embodiment of the present invention. This FCD450 sample was manufactured based on the above-described composition and contents, and a comparative example was manufactured in accordance with the conventional method.

TABLE 2

| | Tensile Strength | Elongation | Hardness | Ferrite Fraction |
|---|---|---|---|---|
| Classifi- | Deviation | Deviation | Deviation | Deviation |
| cation | (Mpa) | (%) | (HB) | (%) |
| Comparative | 170 | 17 | 99 | 69 |
| Example | | | | |
| Example | 13 | 1 | 20 | 8 |

In Table 2, deviations in tensile strength, elongation, hardness and ferrite fraction between the left portion and the right portion on the symmetric plane A were obtained in the Example and the Comparative Example. As shown, variations of the physical properties between the left portion and the right portion in the Example were substantially less than that of Comparative Example. For example, in regard to the ferrite fraction deviation, the fraction deviation of the Comparative Example is about 69%, whereas the faction deviation of the Example is about 8%.

Thus, according to such small deviations in the physical properties of the Example, the Example according to an exemplary embodiment may have uniform physical properties in the bilateral symmetrical microstructure. In addition, the Example may obtain the vibration and noise reduction effect and the NVH performance improvement effect during operation of the disc brake.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method of manufacturing a brake caliper housing, comprising:
injecting a melt into a mold constituted by a cavity of at least one or more of brake caliper housings;
cooling the molded brake caliper housing having symmetric physical properties between a left portion and a right portion of the molded brake caliper housing,
wherein a cooling rate of the melt of a part in which a chiller is installed during cooling is increased to selectively improve strength, by installing the chiller on a outer surface of the cavity.

2. The method of manufacturing the brake caliper housing of claim 1, wherein the cavity has two melt inlets which are positioned symmetrically to each other on a left portion and a right portion of a symmetry plane.

3. The method of manufacturing the brake caliper housing of claim 1, wherein the outer surface of the cavity in which the chiller is installed is an outer surface which corresponds to a contact section of the casted brake caliper housing.

4. The method of manufacturing the brake caliper housing of claim 1, wherein the brake caliper housing is manufactured so that a Young's modulus variation between the left portion and the right portion is within about 5%.

5. The method of manufacturing the brake caliper housing of claim 1, wherein the brake caliper housing is manufactured so that a ferrite structure deviation between the left portion and the right portion is within about 10%.

6. A method of manufacturing a brake caliper housing, comprising steps of:
a first step of melting a ductile cast iron to manufacture a melt;
a second step of injecting the melt through two melt inlets positioned in bilateral symmetry on a left portion and a right portion of the symmetry plane of the cavity of the brake caliper housing shape;
a third step of manufacturing castings by cooling the melt;
a fourth step of separating the manufactured castings from the mold; and
a fifth step of cutting the castings separated from the mold per each brake caliper housing to manufacture the brake caliper housing or the like,
wherein a cooling rate of the melt of a part in which a chiller is installed during cooling is increased to selectively improve strength by installing the chiller on a outer surface of the cavity.

7. The method of manufacturing the brake caliper housing of claim 6, wherein the cavity has two melt inlets which are positioned symmetrically to each other on a left portion and a right portion of a symmetry plane.

8. The method of manufacturing the brake caliper housing of claim 6, wherein the outer surface of the cavity in which the chiller is installed is an outer surface which corresponds to a contact section of the casted brake caliper housing.

9. The method of manufacturing the brake caliper housing of claim 6, wherein the brake caliper housing is manufactured so that a Young's modulus variation between the left portion and the right portion is within about 5%.

10. The method of manufacturing the brake caliper housing of claim 6, wherein the brake caliper housing is manufactured so that a ferrite structure deviation between the left portion and the right portion is within about 10%.

11. A brake caliper housing manufactured by the method of claims 1.
